(19) United States
(12) Patent Application Publication
(10) Pub. No.: US 2015/0178815 A1
(43) Pub. Date: Jun. 25, 2015

(54) PROCESS AND METHOD FOR ORDERING PAINT

(71) Applicant: Michael Cassidy, Atlanta, GA (US)

(72) Inventor: Michael Cassidy, Atlanta, GA (US)

(21) Appl. No.: 14/139,291

(22) Filed: Dec. 23, 2013

(51) Int. Cl. G06Q 30/06; B05D 1/28; B05D 1/02

(52) U.S. Cl. CPC G06Q 30/0635; B05D 1/02; B05D 1/28; G06Q 30/0621

(57) ABSTRACT

Implementations of this disclosure provide processes and methods of ordering paint. In some implementations, a consumer uses a provided color sample to order paint. The color sample has a product identifier thereon used to identify a specific paint formula. The identified paint formula provides the proper proportion of ingredients required to make the color of paint used to color the color sample. This ensures that the consumer receives paint that matches the color sample used to place the order. Implementations of this disclosure allow consumers, for example through a web application, to order paint by using the product identifier of a color sample. After an order is placed, the formula associated with each specified product identifier is transmitted to an authorized retailer who then mixes the ordered paint.

### TECHNICAL FIELD

This disclosure relates to processes and methods of ordering paint.

### BACKGROUND

Paint is routinely used to color, protect, or provide texture to various substrates, such as sheetrock or structural siding. Paint may be comprised of a binder, diluents or solvents, pigments and/or fillers. To purchase a specific color of paint, a potential buyer may visit a retailer and review the provided color samples, generally provided as color palettes or color chips. The color palettes or chips are typically manufactured by printing an approximation of a paint color onto a piece of paper. After selecting a color of paint using a provided color sample, a retailer mixes the paint by using a formula identified by the color samples identification number. The retailer can then check the mixed paint against draw down cards, if the color is correct the customer purchases the paint. If the color is not correct, the retailer may discard the paint and begin the mixing process anew. Draw down cards are made by the retailers employees and may not be consistent between locations.

However, there are several deficiencies with this method and similar methods. First, the provided color samples may not represent the actual color of the paint purchased. Second, a color sample may not reflect how the substrate to be painted affects a paints color. Third, mixing additional quantities of paint at a later date that matches the color of previously purchased paint may be very difficult. This may be particularly problematic if the consumer tries to purchases the same color of paint from a different retailer. Fourth, this and similar methods of mixing paint creates a lot of wasted paint due to the trial and error nature of the mixing process. Additional waste is realized in the form of man hours tied to the color matching process by both retailers and consumers. Fifth, draw down cards are made by the retailers employees and may not be consistent between locations.

### BRIEF DESCRIPTION OF THE DRAWINGS

FIGS. 1A and 1B illustrate a color sample 105 according to the present disclosure.

FIG. 2 illustrates an example environment 200 of the present disclosure for ordering paint.

FIG. 3 illustrates another example environment of the present disclosure for ordering paint.

FIG. 4 illustrates an example computer system that may be used with some implementations of the present invention

### DETAILED DESCRIPTION

Implementations of this disclosure provide processes and methods of ordering paint. In some implementations, a consumer uses a provided color sample to order paint. The color sample has a product identifier thereon used to identify a specific paint formula. The identified paint formula provides the proper proportion of ingredients required to make the color of paint used to color the provided sample. This ensures that the consumer receives paint that matches the color sample used to place the order.

Implementations of this disclosure allow consumers, for example through a web application, to order paint by using the product identifier of a color sample. After an order is placed, the formula associated with each specified product identifier is transmitted to an authorized retailer who then mixes the ordered paint. The retailer may check the mixed paint against a color sample having the same product identifier as the color sample used to order it, prior to customer pick up.

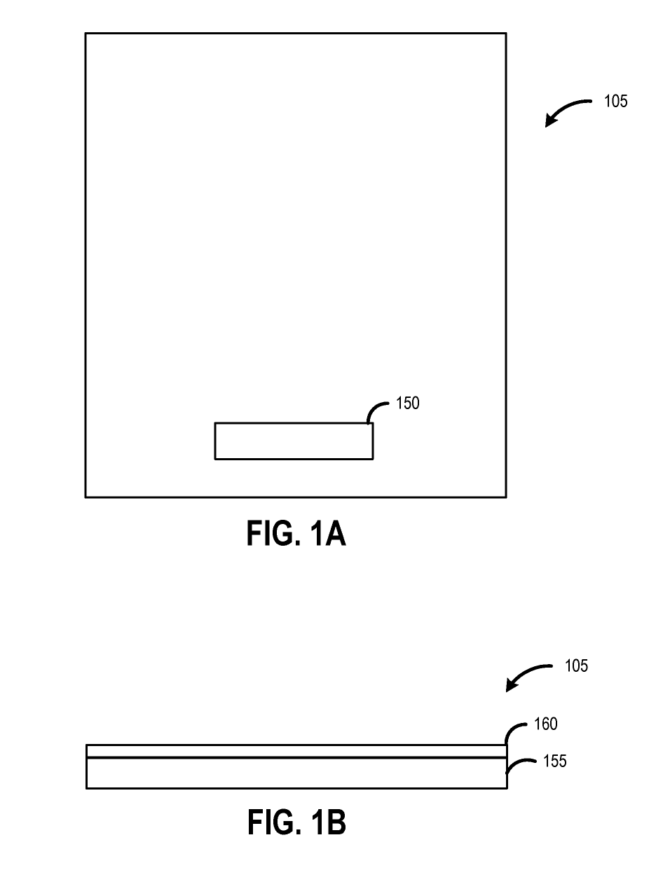

FIGS. 1A and 1B illustrate a color sample 105 used for selecting and ordering paint according to the present disclosure. Implementations of the color sample of the present disclosure may aid in a more accurate visualization of the substrate to be painted with the paint of the color sample.

The color sample 105 may be comprised of a substrate 155, paint 160 and a product identifier 150. In some implementations, the substrate 155 may be made from a material that is generally flat, non-glossy, and/or porous. In some implementations, the substrate 155 material mimics the texture of drywall. In some implementations, paint 160 may be applied to the substrate 155 by rolling, spraying or brushing it on. In some implementations, any suitable method of applying the paint 160 to the substrate 155 may be used. In some implementations, the product identifier 150 may be a hexadecimal value, Red-Green-Blue (RGB) value, name, number, indicia or other suitable method of identification.

The product identifier 150 is used to identify the specific formula used to mix the paint 160 that was applied to the substrate 155 of the color sample 105. By using the product identifier 150 when placing an order for paint 160, the customer may be more confident that the paint 160 they receive may be the same color of paint 160 that was on the color sample 105.

In some implementations, the color sample 105 is 2′ high×2′ wide. The larger size of the color sample 105 may provide the consumer with a better means to judge the appearance of the paint 160 prior to purchase thereby reducing waste. In other implementations, the color sample 105 may be greater than or less than 2′ high×2′ wide.

In some implementations, the color sample 105 is provided as part of a book of color samples 105.

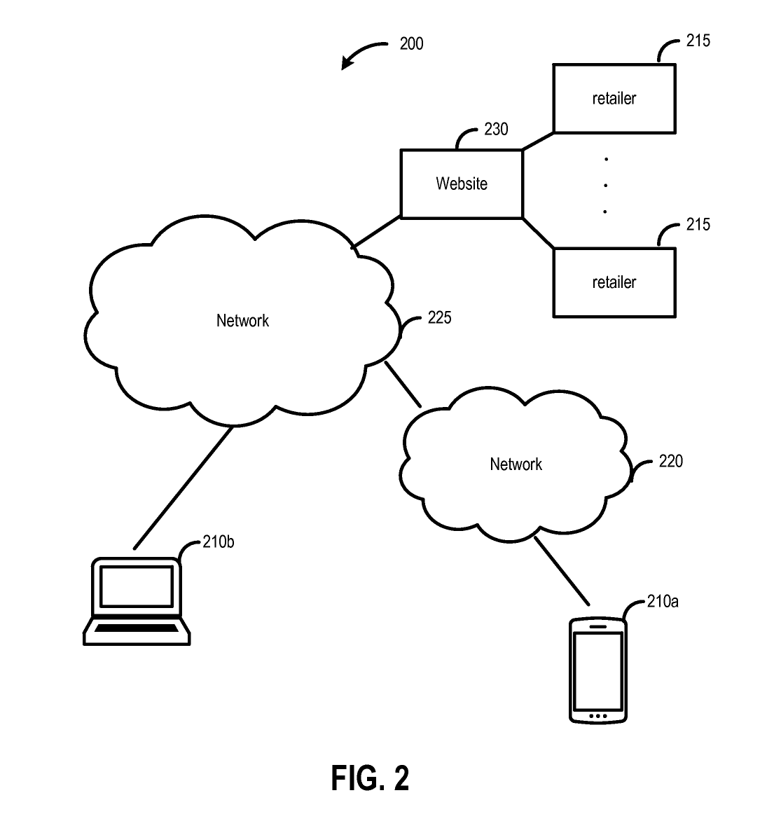

FIG. 2 illustrates an example environment 200 for ordering paint according to the present disclosure.

As shown in FIG. 2, the environment 200 can include client devices 210a and 210b (collectively client device 210), a wireless cellular network 220, a network 225, a website 230 and retailer devices 215. Client devices 210a and 210b are depicted as a mobile phone 210a and desktop computer 210b, respectively, but client devices 210 may comprise any type of computing device, such as a desktop computer system, a laptop, a smartphone, a mobile telephone, a tablet-style computer, or any other handheld electronic device.

In some implementations, the client device 210a can connect to the network 225 through a wireless cellular network 220, such as GPRS-based and CDMA-based wireless networks, as well as 802.16 WiMax and long-range wireless data networks.

Client devices 210a and 210b can interact with the website 230 via an application, such as a web browser or a native application, residing on the client devices 210a and 210b to place an order for paint 160 using the product identifier 150 of a color sample 105.

In some implementations, applications (e.g., server and/or client applications) used to place an order for paint 160 through the website 230 are configured to associate the user inputted product identifier 150 of a color sample 105 with a paint 160 formula stored on a data storage communicatively connected to the website 230/server. The paint 160 formula and other order information is then transmitted (e.g., via one or more wired, wireless, or optical links) from the website 230 to a retailer device 215. Retailer devices 215 may comprise any type of computing device, such as a desktop computer system, a laptop, a smartphone, a mobile telephone, a tablet-style computer, or any other electronic device. An employee at a retailer location can then mix the ordered paint 160 using the provided formula (s). In some implementations, the color of the mixed paint 160 then may be checked against a color sample 105 having the sample product identifier 150 prior to customer pick up. In some implementations, the customer may check the mixed paint 160 with the color sample 105 prior to purchasing the paint.

By ordering paint 160 through a website 230 which transmits a formula used to mix the specific color of paint 160 found on the color samples 105 used to select the ordered paint 160, the consumer may purchase identically formulated paint 160 from a variety of participating retailers in the same or different geographic locations.

In some implementations, a customer may contact a customer service representative to place an order for paint using the product identifier 150 of a color sample 105. The customer service representative will input the customer provided product identifier 150 into a retailer device 215 or client device 210 that uses an application to transmit the provided information to the website 230. The website 230 then replies to a retailer device 215 with the formula required to mix the color of paint 160 associated with the provided product identifier 150.

In some implementations, the website 230 provides a system to organize a buyback program where the consumer can return unused paint to a retailer.

In some implementations, a network is established to allow consumers to directly swap or sell paint 160 purchased using a color sample 105 through the website 230.

In some implementations, the paint 160 formula may be varied to increase or decrease the intensity of a paints 160 color. In some implementations, the paint 160 formula may be a mixture of pigments added to a combination of binders, diluents or solvents, and possibly fillers. In some implementations, the volume of pigment added may be varied between 50% and 200% of the original volume of pigment used to formulate a particular paint 160. This would allow the consumer to vary the shade of a paints 160 color.

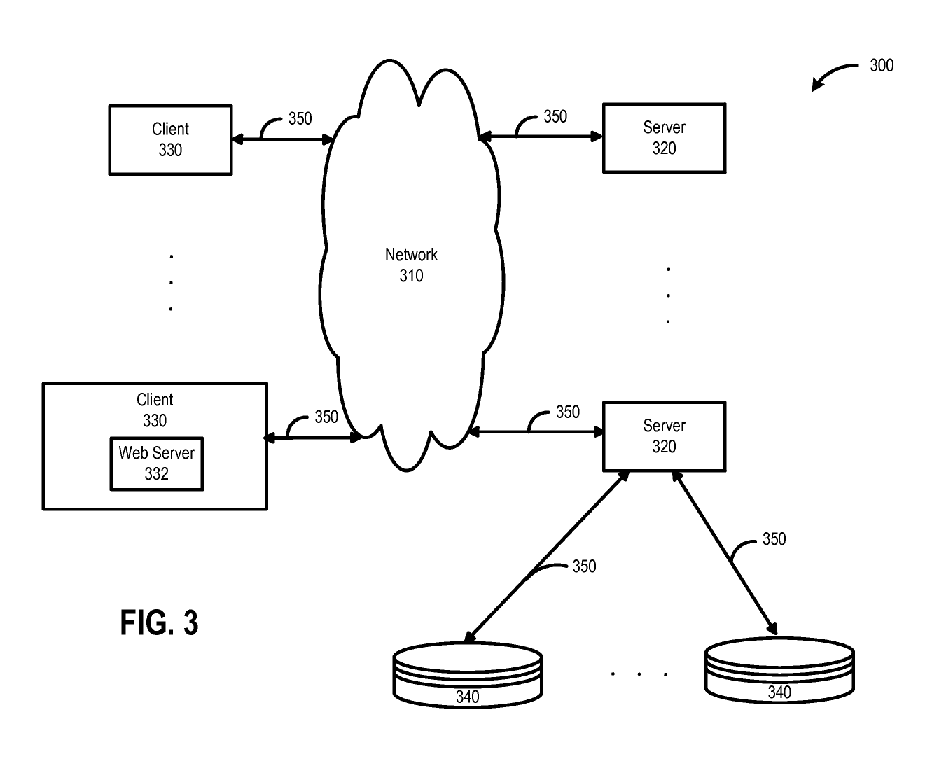

FIG. 3 illustrates another example environment 300 of the present disclosure for ordering paint using a product identifier as described above. The example environment 300 can include a network 310, one or more servers 320, and one or more clients 330. In some implementations, a client 330 may be a retailer device as described above. The example environment 300 also can include one or more data storage 340 linked to one or more servers 320. Particular embodiments may be implemented in network environment 300. For example, applications used to render the user interfaces to perform the functions described above may be written in software programs hosted by one or more servers 320.

In some implementations, network 310 may be an intranet, an extranet, a virtual private network (VPN), a local area network (LAN), a wireless LAN (WLAN), a wide area network (WAN), a metropolitan area network (MAN), a portion of the Internet, or another network 310 or a combination of two or more such networks 310. The present disclosure contemplates any suitable network 310.

One or more links 350 couple a server 320 or a client 330 to network 310. In some implementations, one or more links 350 each can include one or more wired, wireless, or optical links 350. In some implementations, one or more links 350 each can include an intranet, an extranet, a VPN, a LAN, a WLAN, a WAN, a MAN, a portion of the Internet, or another link 350 or a combination of two or more such links 350. The present disclosure contemplates any suitable links 350 coupling servers 320 and clients 330 to network 310.

In some implementations, each server 320 may be a unitary server or may be a distributed server spanning multiple computers or multiple datacenters. Servers 320 may be of various types, such as, for example and without limitation, web server, file server, application server, exchange server, database server, or proxy server. In some implementations, each server 320 may include hardware, software, or embedded logic components or a combination of two or more such components for carrying out the appropriate functionalities implemented or supported by server 320. For example, a web server is generally capable of hosting websites containing web pages or particular elements of web pages. More specifically, a web server may host HTML files or other file types, or may dynamically create or constitute files upon a request, and communicate them to clients 330 in response to HTTP or other requests from clients 330. A database server is generally capable of providing an interface for managing data stored in one or more data stores.

In some implementations, one or more data storages 340 may be communicatively linked to one or more servers 320 via one or more links 350. In some implementations, data storages 340 may be used to store various types of information. In some implementations, the information stored in data storages 340 may be organized according to specific data structures. In particular embodiment, each data storage 340 may be a relational database. Particular embodiments may provide interfaces that enable servers 320 or clients 330 to manage, e.g., retrieve, modify, add, or delete, the information stored in data storage 340.

In some implementations, each client 330 may be an electronic device including hardware, software, or embedded logic components or a combination of two or more such components and capable of carrying out the appropriate functions implemented or supported by client 330. For example and without limitation, a client 330 may be any type of computing device such as a desktop computer system, a laptop, a smartphone, a mobile telephone, a tablet-style computer, or any other handheld electronic device. The present disclosure contemplates any suitable clients 330. A client 330 may enable a network user at client 330 to access network 330. A client 330 may enable its user to communicate with other users at other clients 330.

A client 330 may have a web browser 332, such as MICROSOFT INTERNET EXPLORER, GOOGLE CHROME, MOZILLA FIREFOX, or any other future developed web browser and may have one or more add-ons, plug-ins, or other extensions. A user at client 330 may enter a Uniform Resource Locator (URL) or other address directing the web browser 332 to a server 320, and the web browser 332 may generate a Hyper Text Transfer Protocol (HTTP) request and communicate the HTTP request to server 320. Server 320 may accept the HTTP request and communicate to client 230 one or more Hyper Text Markup Language (HTML) files responsive to the HTTP request. Client 330 may render a web page based on the HTML files from server 320 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

In some implementations, a client 330 having a web browser 332 can connect to a server 320 to order paint using a product identifier. In some implementations, a paint 160 formula associated with a product identifier may be stored in a data storage 340 communicatively linked to the servers 320. In some implementations, the data storage 340 may be a database. In some implementations, the client 330 and/or server 320 used to order paint are configured to associate the user inputted product identifier 150 of a color sample 105 with a paint 160 formula stored on a data storage 340.

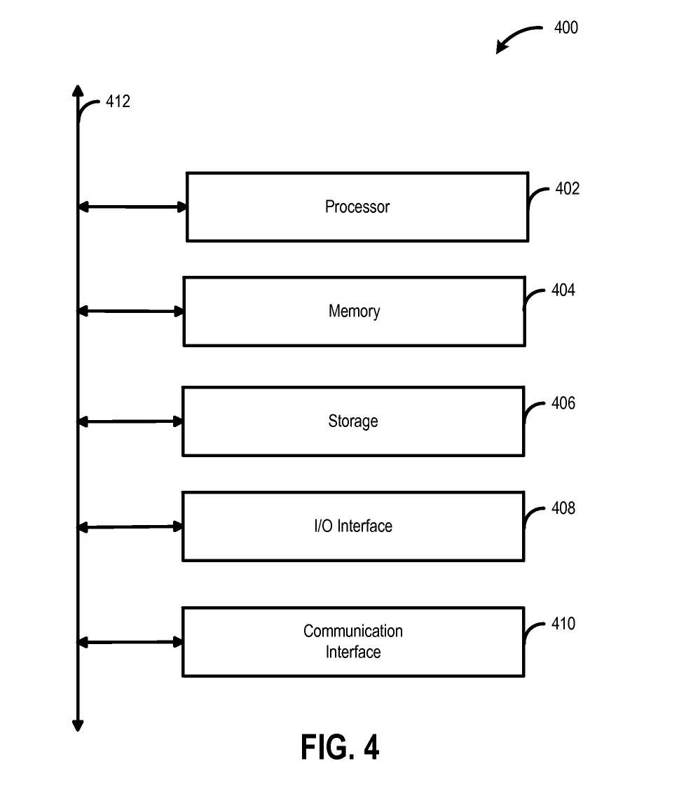

FIG. 4 illustrates an example computer system 400, which may be used with some embodiments of the present invention. This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these. Where appropriate, computer system 400 may include one or more computer systems 400; be unitary or distributed; span multiple locations; span multiple machines; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In some implementations, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In some implementations, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In some implementations, processor 402 may include one or more internal caches for data, instructions, or addresses. The present disclosure contemplates processor 402 including any suitable number of any suitable internal caches, where appropriate. As an example and not by way of limitation, processor 402 may include one or more instruction caches, one or more data caches, and one or more translation look-aside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In some implementations, processor 402 may include one or more internal registers for data, instructions, or addresses. The present disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In some implementations, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In some implementations, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In some implementations, one or more memory management units (MMUs) reside between processor 402 and memory 404 and facilitate accesses to memory 404 requested by processor 402. In some implementations, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 404 may include one or more memories 402, where appropriate. Although this disclosure describes and illustrates particular memory, this disclosure contemplates any suitable memory.

In some implementations, storage 406 includes mass storage for data or instructions. As an example and not by way of limitation, storage 406 may include an HDD, a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In some implementations, storage 406 is non-volatile, solid-state memory. In some implementations, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In some implementations, I/O interface 408 includes hardware, software, or both providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In some implementations, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In some implementations, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

This disclosure contemplates one or more computer-readable storage media implementing any suitable storage. In some implementations, a computer-readable storage medium implements one or more portions of processor 602 (such as, for example, one or more internal registers or caches), one or more portions of memory 604, one or more portions of storage 606, or a combination of these, where appropriate. In some implementations, a computer-readable storage medium implements RAM or ROM. In some implementations, a computer-readable storage medium implements volatile or persistent memory. In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In some implementations, software includes one or more application programming interfaces (APIs). This disclosure contemplates any suitable software written or otherwise expressed in any suitable programming language or combination of programming languages. In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code). In some implementations, software is expressed in JAVA. In some implementations, software is expressed in Hyper Text Markup Language (HTML), Extensible Markup Language (XML), or other suitable markup language.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website. Any computer-based system that provides networking functionality can be used in accordance with the present invention even if it relies, for example, on email, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

1. A paint color sample comprising
a substrate layer;
a paint layer on top of the substrate layer, and
a product identifier.

2. The paint color sample of claim 1 wherein the substrate layer is porous and non-glossy.

3. The paint color sample of claim 1 wherein the substrate layer comprises a sheet rock material.

4. The paint color sample of claim 1 wherein the substrate layer comprises a cardboard material.

5. The paint color sample of claim 1 wherein the sample is at least 5 inches wide and 5 inches high.

6. A method of manufacturing a paint color sample, the paint color sample comprising a substrate layer, a paint layer, and a product identifier, the method comprising:
applying a layer of paint to at least one side of the substrate layer; and
applying a product identifier to the paint color sample.

7. The method of claim 6 wherein applying a layer of paint to at least one side of the substrate layer comprising rolling a layer of paint onto at least one side of the substrate layer.

8. The method of claim 6 wherein applying a layer of paint to at least one side of the substrate layer comprising spraying a layer of paint onto at least one side of the substrate layer.

9. The method of claim 6 wherein applying a layer of paint to at least one side of the substrate layer comprising brushing a layer of paint onto at least one side of the substrate layer.

10. A computer-implemented process of using a paint color sample, the paint color sample comprising a substrate layer, a paint layer, and a product identifier, to order paint, the process comprising:
receiving a paint color sample product identifier;
associating the product identifier with a formulas; and
transmitting the formula to a receiving device.

11. The computer-implemented process of claim 10 further comprising receiving the formula at the receiving device and making the paint using the formula.

12. The computer-implemented process of claim 11, further comprising the step of checking the color of the mixed paint against a paint color sample having the product identifier associated with the formula used to mix the paint.

13. The computer-implemented process of claim 11 wherein the paint color sample product identifier is received at a first location and the formula is transmitted to a second location, wherein the first location and second location are in two separate physical locations.
